(19) United States
(12) Patent Application Publication
(10) Pub. No.: US 2012/0086276 A1
(43) Pub. Date: Apr. 12, 2012

(54) Supplying Power To An Electronic Device Using Multiple Power Sources

(76) Inventor: Thomas P. Sawyers, Hempstead, TX (US)

(21) Appl. No.: 12/992,275

(22) PCT Filed: Oct. 12, 2010
(86) PCT No.: PCT/US10/52268

§ 371 Date: Nov. 12, 2010

(51) Int. Cl. H02J 7/34; H02J 1/10

(52) U.S. Cl. 307/66; 307/72

(57) ABSTRACT

An electronic device includes multiple power sources (102, 104, 202, 206, 302, 304) that can provide power to a load (106, 208, 306) in the electronic device. A DC-DC converter (110, 204, 310) is provided between one of the multiple power sources and the load.

### BACKGROUND

Electronic devices typically have input power connections for connecting to an AC power source, such as a wall outlet. In some cases, particularly when the electronic devices are portable electronic devices, batteries can also be provided in the electronic devices for powering the electronic devices when they are not connected to the external AC power source.

### BRIEF DESCRIPTION OF THE DRAWINGS

Some embodiments are described with respect to the following figures:

FIGS. 1 and 2 are block diagrams of example electronic devices incorporating a power subsystem according to some embodiments;

FIGS. 3A-3D are block diagrams of an example electronic device incorporating a power subsystem according to alternative embodiments;

FIG. 4 is a circuit diagram of a power subsystem according to further embodiments;

FIGS. 5A-5B are circuit diagrams of a power subsystem according to additional embodiments;

FIG. 6 is a flow diagram of a process of supplying power to a load according to some embodiments.

### DETAILED DESCRIPTION

An electronic device includes various components that are powered to allow the components to perform their respective functions. Examples of components in electronic devices include processors, storage devices (e.g., memory devices and/or disk-based storage devices), input/output (I/O) devices, and so forth.

A typical power source used to provide power to an electronic device is an AC adapter, which converts AC voltage to DC voltage. The AC adapter receives power from an AC source such as a wall outlet. Normally, the AC adapter is able to supply the power consumed by the load of the electronic device. A “load” in an electronic device refers to the components (such as those noted above) in the electronic device that are drawing power. The “load” can also include power supply circuitry within the electronic device (including converters and/or regulators) that supply power voltages at specified levels to the components.

In some scenarios, the load of the electronic device may temporarily draw extra power that can exceed the rated power of the AC adapter (in other words, the power consumption of the load exceeds the maximum power that can be provided by the AC adapter). In such an overload condition, the AC adapter may overheat, malfunction, and/or shut down, or simply exceed a regulatory rating.

In the examples discussed above, the AC adapter is considered a primary power source since the AC adapter supplies power so long as the AC adapter is available (the AC adapter is plugged into the external AC source and is connected to the electronic device). In other examples, the primary power source can be a different type of power source, such as a solar panel, a network power source, or a battery. A “network power source” refers to a source of power from a network that is used for communicating data. For example, the network can be an Ethernet network, with power provided over a cable of the Ethernet network.

In accordance with some implementations, to handle a temporary spike in power consumption by the load of an electronic device that exceeds the power rating of a primary power source (a power overload condition), a supplemental power source is provided that can be switched into the power path to supplement the power provided to the load, such that the combination of the power from the primary power source and the power of the supplemental power source is sufficient to supply the temporarily heightened power consumption of the load.

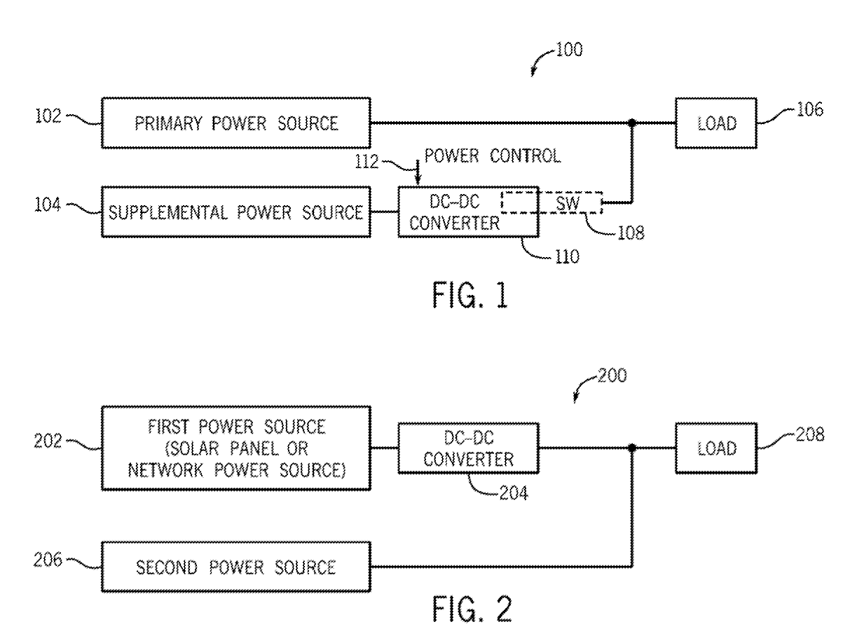

FIG. 1 is a block diagram of an example arrangement of an electronic device 100, which includes a primary power source 102 and a supplemental power source 104. The primary power source 102 is connected to a load 106 of electronic device 100. Although the primary power source 102 is depicted as being connected directly to the load 106, note that there can be various circuitry in the connection path between the primary power source 102 and the load 106, such as diodes, transistors, resistors, inductors, and so forth. Thus, a power source is “electrically connected” to a load if the power source is connected directly to the load by conductor(s), or connected through various circuitry.

The electrical connection between the primary power source 102 and the load 106 is used to represent that power is drawn by the load 106 from the primary power source 102 so long as the primary power source 102 is available.

A DC-DC converter 110 is provided at the output of the supplemental power source 104. The DC-DC converter 110 converts the output voltage of the supplemental power source 104 to a second voltage that is provided as an output to the load 106. In some implementations, the DC-DC converter 110 effectively converts the supplemental power source 104 into a current source, such that current from the DC-DC converter 110 can be summed with the output of the primary power source 102. The summing of power from the primary and supplemental power sources provides an enhanced amount of power to the load 106.

The output voltage of the DC-DC converter 110 can be the same as or different from the output voltage of the supplemental power source 104. In implementations where the output voltage level of the supplemental power source 104 is different from the output voltage level of the primary power source, the DC-DC converter 110 can be used to change the voltage level of power from the supplemental power source 104 to the voltage level of the primary power source 102.

In some examples, if the output voltage level of the primary power source 102 is greater than the output voltage level of the supplemental power source 104, the DC-DC converter 110 is a step up converter to step up the voltage level of the supplemental power source 104 to the voltage level of the primary power source 102.

In other examples, the output voltage level of the supplemental power source 104 is less than the output voltage level of the primary power source 102, in which case the DC-DC converter 110 is implemented as a step down converter to step down the voltage level of the supplemental power source 104 to the voltage level of the primary power source 102.

Switch circuitry 108 is provided for controlling selective electrical coupling of the supplemental power source 104 to the load 106. Note that the switch circuitry 108 can be implemented with one or multiple switches (such as field-effect transistors) connected between the output of the DC-DC converter 110 and the load 106. Alternatively, the switch circuitry 108 can be implemented as enable circuitry inside the DC-DC converter, where the enable circuitry controls whether or not the power from the DC-DC converter is electrically connected to the load 106. If disabled (such as by deactivating an enable input to the DC-DC converter), the enable circuitry inside the DC-DC converter 110 prevents power from being output by the DC-DC converter 110 to the load 106. If enabled (such as by activating an enable input to the DC-DC converter), the enable circuitry inside the DC-DC converter 110 allows power to be output by the DC-DC converter 110 to the load 106. In some examples, the enable input of the DC-DC converter 110 can be a power control input 112 as depicted in FIG. 1. Alternatively, the enable input can be another input of the DC-DC converter 110.

More generally, in an inactive slate, the switch circuitry 108 electrically isolates the supplemental power source 104 from the load 106. In an active state, the switch circuitry 108 electrically couples the supplemental power source 104 to the power input of the load 106, such that the load 106 draws power from both the primary power source 102 and the supplemental power source 104.

In some implementations, in addition to enabling or disabling the DC-DC converter 110, the power control input 112 also controls the amount of power delivered by the DC-DC converter 110 to the load 106. The power delivered by the DC-DC converter 110 is equal to the amount of additional power that has to be supplied by the supplemental power source 104 to satisfy the current power consumption of the load 106 (which exceeds the power rating of the primary power source 102).

In some examples, the power control input 112 can be based on an error signal. When the power consumed by the load 106 exceeds a threshold (which corresponds to a power rating of the primary power source 102), the error signal can be activated. This error signal causes activation of the switch circuitry 108 and controls the amount of current drawn from the DC-DC converter 110 for summing with the power drawn from the primary power source 102. As the power consumed by the load 106 increasingly exceeds the threshold, the error signal can increase in amplitude to cause more current to be drawn from the DC-DC converter 110 to sum with the power of the primary power source 102.

In some implementations, a second threshold can be set such that when the supplemental power source 104 delivers so much power that the supplemental power source 104 can no longer supply additional power, a throttling command can be issued to the load 106 to cause the load to throttle (reduce) its power consumption to prevent the overloading of both the primary and supplemental power sources 102 and 104. Throttling can cause reduction of power consumption by one or multiple components of the load 106, such as a processor and/or other component.

The power drawn from the supplemental power source 104 is less than or equal to the load power drawn by the load 106, such that current is not back fed to the primary power source 102 (in other words, current continues to flow from the primary power source 102 to the load 106). In this manner, the voltage level of the output of the primary power source 102 is not changed much—in some examples, if the primary power source 102 has an output impedance greater than zero, the output voltage level of the primary power source 102 can be raised slightly; this allows the output voltage of the primary power source 102 to continue to power the load 106.

In some examples, the primary power source 102 is an AC adapter, and the supplemental power source 104 is a battery. In other examples, the primary power source 102 and supplemental power source 104 can be implemented with other types of power sources, such as a solar panel, a network power source, and so forth.

Although just one supplemental power source 104 is depicted in FIG. 1, it is noted that techniques or mechanisms according to some implementations can be applied to arrangements with one or multiple additional supplemental power sources.

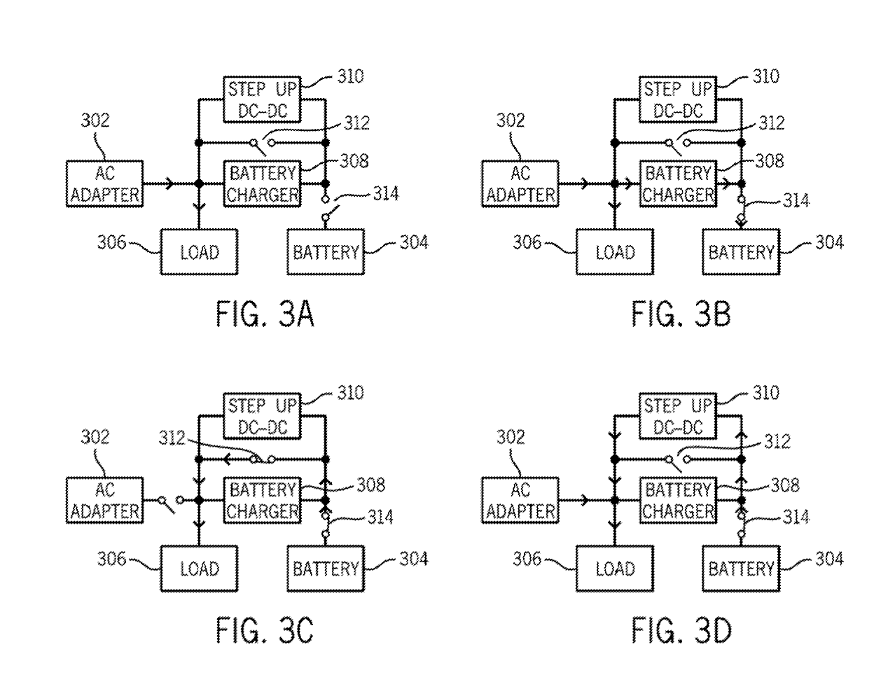

FIG. 2 is a block diagram of an example arrangement of an electronic device 200 according to alternative implementations. The electronic device 200 includes a first power source 202 and a second power source 206. In some implementations, the first power source 202 is a solar panel or a network power source. The second power source 206 can be a battery or an AC adapter, as examples.

The output of the first power source 202 is connected through a DC-DC converter 204 (which can be a step up or step down DC-DC converter) to a load 208 of the electronic device 200. The output of the second power source 206 is also connected to the load 208. Although shown as direct connections, note that the DC-DC converter 204 and/or second power source 206 can be connected to the load 208 through various circuitry, such as resistors, transistors, diodes, inductors, and so forth.

In the arrangement of FIG. 2, the load 208 draws power from both the first and second power sources 202 and 206. In alternative implementations, switch circuitry can be associated with the DC-DC converter 204 and/or the second power source 206 to selectively connect one or both of the first and second power sources to the load 208. In such implementations, the DC-DC converter 204 is controlled to control provision of power from the first power source 202 to the load 208, where the DC-DC converter 204 is controlled by (1) preventing power from being supplied from the second power source 206 to the load 208 if a power demand of the load can be met by the first power source, and (2) controlling the DC-DC converter 204 to supply a current that is combined with an output of the second power source 206 if the power demand of the load exceeds an amount of power that can be met by the first power source. For example, if the first power source 202 can meet the demand of load 208, the output voltage or current from the DC-DC converter 204 is increased until the load drawn from second power source 206 is reduced to zero.

In implementations where the first power source 202 is a solar panel, the output voltage from the solar panel 202 is provided to the input of the DC-DC converter 204. The DC-DC converter 204 adds output current to the power provided by the second power source 206 that is powering the load 208. If the energy available from the solar panel 202 exceeds the energy that is used by the load 208, the DC-DC converter 204 does not draw all the available energy from the solar panel 202. If the energy available from the solar panel is less than what is consumed by the load 208, the output of the DC-DC converter 204 can be current limited, so as to not overload the solar panel 202. To maximize the power drawn from the solar panel 202, optimum power point techniques can be used to set and vary the current limit of the solar panel 202. Such techniques may be implemented independently, or may be integrated together with the DC-DC converter 204.

In other implementations in which the first power source 202 is a network power source (e.g., an Ethernet power source supplied from an Ethernet network), the DC-DC converter 204 can be implemented with transformer isolation.

The power provided by the first power source 202 (implemented with a solar panel or network power source) would decrease the energy drawn from the second power source 206. In fact, in some implementations, if the power draw by the load 208 is less than that provided by the first power source 202, the remaining power provided by the first power source 202 can be used to recharge the second power source 206 in implementations in which the second power source 206 is implemented with one or multiple batteries. If the average load power (consumed by the load 208) is less than or equal to the available power from the first power source 202, the battery would not become fully discharged, regardless of peak power draw. To take full advantage of this, the electronic device 200 can enter into a lower power mode of operation to indefinitely maintain some charge in the battery.

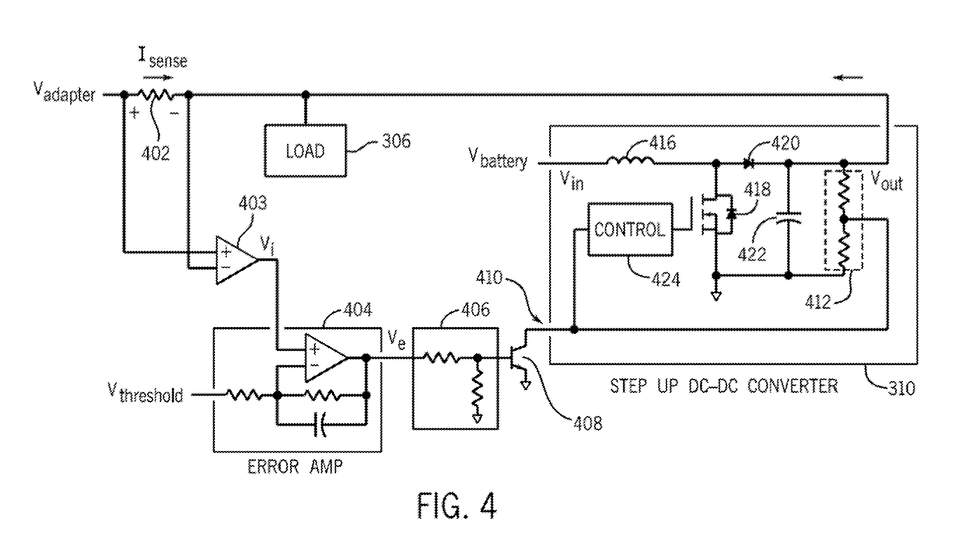

FIGS. 3A-3D are abstract depictions of an electronic device according to further implementations. In each of FIGS. 3A-3D, two power sources are provided, in the form of an AC adapter 302 and a battery 304. In FIG. 3A, the AC adapter 302 is connected to a load 306, with arrows in FIG. 3A representing current flowing from the AC adapter 302 to the load 306. In the examples depicted, the AC adapter voltage is assumed to be greater than the battery voltage—in such examples, a DC-DC converter 310 is implemented as a step up converter, while a battery charger 308 is implemented as a step down converter. Note that in alternative implementations, the DC-DC converter 310 and battery charger 308 can be implemented as a step down converter and step up converter, respectively, if the AC adapter voltage is less than the battery voltage. It is noted that various mechanisms or techniques described herein are intended to cover any combination of AC adapter voltage and battery voltage.

The electronic device of FIG. 3A includes the battery charger 308 (for charging the battery 304) and the step up DC-DC converter 310 (similar to the DC-DC converter 110 of FIG. 1). Also, a switch 314 is provided to control whether the battery 304 is connected to a power subsystem (including the battery charger 308, step up DC-DC converter 310, and the switch 312). Assuming the switch 314 is closed, another switch 312 controls whether the battery 304 is supplying power by electrically connecting the battery 304 to the load 306, or the battery is supplying power through the step up DC-DC converter 310.

In the arrangement of FIG. 3A, the switches 312 and 314 are open, such that the battery 304 is disconnected from the power subsystem. The switch 314 can be in the open position when the battery 304 is fully charged and does not need to be charged any further, and the AC adapter 302 is available to power the load 306.

In FIG. 3B, the switch 314 has been closed, such that the battery charger 308 is connected to the battery 304. In this arrangement, the AC adapter 302 powers both the load 306 and also charges the battery 304 through the battery charger 308 (as represented by arrows in FIG. 3B).

In the FIG. 3C arrangement, the AC adapter 302 is disconnected from the power subsystem. This may occur, such as when the AC adapter 302 is disconnected from the wall outlet, or the user has disconnected the AC adapter from the electronic device. Upon detection that the AC adapter 302 is no longer available, the switch 312 closes, such that the battery 304 can provide power to the load 306. Note that in the arrangement of FIG. 3C, the output of the battery 312 is provided to the load 306 without passing through the DC-DC converter 310, since the switch 312 is closed. In some implementations, the DC-DC converter 310 may be configured (under the condition where the AC adapter 302 is not available) to pass current through from battery 304 to load 306 (in which case switch 312 can be omitted).

In FIG. 3D, the load 306 is powered by both the AC adapter 302 and the battery 304. In the arrangement of FIG. 3D, the switch 312 is open, but the switch 314 is closed. The arrangement of FIG. 3D may result from a temporary condition when the load 306 is drawing more power than the AC adapter 302 is able to supply. In this case, the battery 304 provides supplemental power to the load 306 through the step up DC-DC converter 310.

Note that in the arrangement of FIG. 3D, the battery charger 308 is not charging the battery 304.

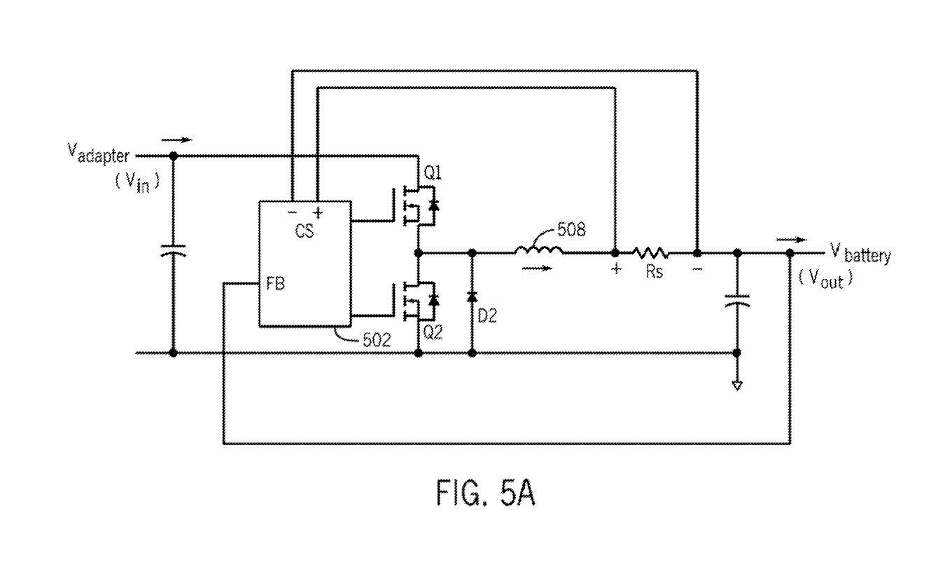

In some implementations, a current sensor can be used for detecting whether the AC adapter is in overload condition (a condition where the AC adapter is unable to supply current that is being demanded by the load). FIG. 4 illustrates an example arrangement in which a current sensor is used for detecting whether or not the AC adapter is in an overload condition. In the example of FIG. 4, the current sensor for determining whether or not the output current from the AC adapter is in an overload condition includes a sense resistor 402, a differential amplifier 403, and an error amplifier 404. Note that the sense resistor 402, differential amplifier 403, and error amplifier 404 can be implemented in either the AC adapter or on a circuit board of the electronic device.

A feedback signal Vi output by the differential amplifier 403 is proportional to a measured adapter current, as measured through the sense resistor 402. The sense resistor 402 is connected to the output voltage (Vadapter) of the AC adapter, and the current from the AC adapter flows through the sense resistor 402 to the load 306 (the current through the sense resistor 402 is represented as Isense). The + input of the differential amplifier 403 is connected to one side of the sense resistor 402, and the − input of the differential amplifier 403 is connected to the other side of the sense resistor 402.

In some implementations, the output of the DC-DC converter 310 is nominally set to regulate at a point below the nominal voltage (Vadapter) of the AC adapter (wherein the output voltage level of the DC-DC converter can be set to be a predefined voltage below the voltage level of Vadapter). In this manner, the DC-DC converter 310 nominally delivers no current if Vadapter is detected to be high enough (based on the comparison of Vi to a threshold voltage, Vthreshold, by the error amplifier 404).

The feedback voltage Vi output by the differential amplifier 403 (where Vi is proportional to the measured adapter current through the sense resistor 402) is compared to the threshold voltage, Vthreshold, by the error amplifier 404. The output of the error amplifier 404 provides an error signal Ve, which is connected through a resistor network 406 to the base of a bipolar junction transistor 408.

The emitter of the bipolar junction transistor 408 is connected to a reference voltage (such as a ground voltage), and the collector of the bipolar junction transistor 408 is connected to a control input 410 of the DC-DC converter 310. In other examples, instead of using the resistor network 406 and bipolar junction transistor 408, other types of control elements can be used, such as control elements including a field effect transistor.

If the current of the AC adapter is low enough such that the feedback voltage Vi is less than Vthreshold, then that is an indication that the load 306 is consuming an amount of power that can be supplied by the AC adapter. In this case, the error signal Ve is at an “off” level (e.g., zero volts), and the transistor 408 is off and drawing no current from the control input 410 of the DC-DC converter 310 to ground.

On the other hand, if the current of the AC adapter is high enough such that the feedback voltage Vi exceeds Vthreshold, then that is an indication of an overload condition, where the load 306 is demanding more power than can be supplied by the AC adapter (in other words, the current drawn from the AC adapter exceeds a threshold current corresponding to Vthreshold). In this scenario, the error signal Ve output by the error amplifier 404 is at an “on” level (e.g., greater than zero volts), which causes the transistor 408 to draw current from the control input 410 of the DC-DC converter 310. This draw of current through the transistor 308 causes the voltage level of the output (Vout) of the DC-DC converter 310 to rise. The rise in the Vout causes current to be drawn from the battery (from the Vbattery input of the DC-DC converter 310).

Note that the error signal Ve is an analog signal whose voltage level varies depending upon the difference between Vi and Vthreshold. The greater that Vi is over Vthreshold, the higher the voltage level of Ve and the more the current draw by the transistor 408. This in turn causes a greater amount of current to be drawn from the battery through the DC-DC converter 310 for supply to the load 306.

The output stage of the DC-DC converter 310 includes a resistor network 412, where a node between the resistors of the resistor network 412 is connected to the control input 410 of the DC-DC converter 310. The transistor 408 when activated draws current from this node of the resistor network 312, to vary Vout of the DC-DC converter 310. If available, some current limit or soft start control may be used to effect the control of Vout in DC-DC converter 310.

The DC-DC converter 310 also includes a boost converter stage, which includes an inductor 416, a transistor switch 418 (e.g., a field effect transistor), a diode 420, a capacitor 422, and control circuitry 424 that controls operation of the boost converter stage.

Using the circuitry depicted in FIG. 4, as the output current of the AC adapter reaches a predefined threshold (where the threshold corresponds to the rated power of the AC adapter), the DC-DC converter 310 is controlled (through the control input 410) to draw power from the battery such that the battery can provide any additional power requested by the load 306 that cannot be supplied by the AC adapter. The output (Ve) of the error amplifier 404 is designed to cause increasing current to flow through the transistor 408 as the load 306 consumes more power that cannot be supplied from the AC adapter—the increased current through the transistor 408 causes an increased current to be drawn from the battery for provision to the load 306 at the output of the DC-DC converter.

Using the circuitry depicted in FIG. 4, the AC adapter delivers up to, but not more than, its rated power, with the remaining power consumed by the load 306 being drawn from the battery. Alternatively, the threshold Vthreshold may also be set to some lower voltage, corresponding to some desired current or power level lower than the rated current or power of the AC adapter.

In some implementations, the step up DC-DC converter 310 and battery charger 308 of FIGS. 3A-3D can be implemented as separate components. Thus, the DC-DC converter 310 depicted in FIG. 4 can be separate from the battery charger 308 shown in FIG. 3A-3D.

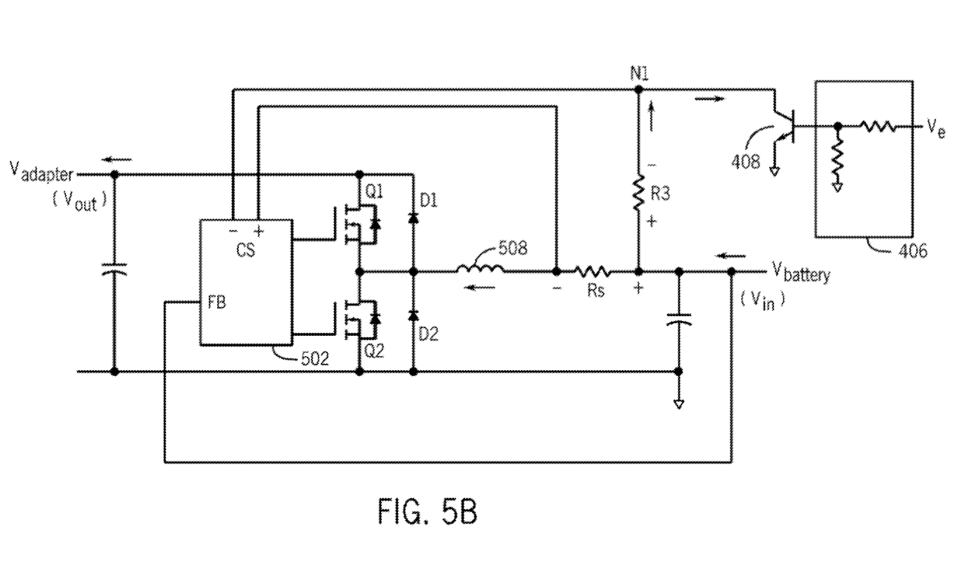

In alternative implementations, to enhance efficiency by reducing the amount of circuitry in an electronic device, the battery charger 308 and DC-DC converter 310 depicted in FIGS. 3A-3D can be integrally formed into the integrated module, by modifying the design of the battery charger. This integrated module operates as a step up DC-DC converter under certain conditions, and operates as a step down battery charger under different conditions. An example arrangement of an integrated battery charger and step up DC-DC converter is shown in FIG. 5B. Integrating different functionalities into a common integrated module can reduce electromagnetic interference issues even though a DC-DC converter functionality is added to provide supplemental power.

FIG. 5A shows a battery charger (without a step up DC-DC converter). The battery charger shown in FIG. 5A is a buck converter, which is a step down DC-DC converter. The battery charger depicted in FIG. 5A receives as input the output (Vadapter) of the AC adapter, and supplies current to the battery (via Vbattery). The battery charger of FIG. 5A has a control circuit 502, which has a feedback input (FB) connected to the output of the battery charger, and current sense (CS) inputs for sensing current through a sense resistor Rs. Outputs of the control circuit 502 control the gates of respective field-effect transistors (FETs) Q1 and Q2. Transistors Q1 and Q2 are connected in series between the battery charger input (Vadapter) and a reference voltage (such as ground).

During normal operation, the upper transistor Q1 (which operates as a switch) is modulated with a pulse-width modulated (PWM) drive signal from the control circuit 502, so that either the output voltage is regulated based on the voltage feedback FB, or the output current is regulated based on the sensed current (sensed by the CS inputs). The lower transistor Q2 is used as a synchronous rectifier—the transistor Q2 acts as a closed switch while a diode D2 (connected in parallel with the transistor Q2) is conducting, since the transistor Q2 has a lower voltage drop and power loss than the diode D2.

The battery charger depicted in FIG. 5A is operated in continuous conduction mode, where the transistor Q2 is on whenever Q1 is off (except during turn-on or turn-off transitions, as Q1 and 02 should not be on at the same time). The continuous conduction mode is used when the battery charge current is high enough to ensure that the instantaneous inductor current (through inductor 508) flows from input (Vadapter) to output (Vbattery), as represented by arrows in FIG. 5A.

At light loads, the battery charger of FIG. 5A does not operate in continuous conduction mode. It is designed to prevent instantaneous inductor current from reversing, as this would circulate energy between input and output, which is less efficient. Also, because the load is a battery, it could potentially draw average current from the battery and dump this current into the source voltage (Vadapter), which if uncontrolled could raise the voltage at the power source (AC adapter) to an unacceptably high level. However, in accordance with some implementations, as depicted in FIG. 5B, a controlled current draw can be allowed from the battery to the AC adapter to allow for the battery to provide supplemental current that is demanded by a load that cannot be supplied from the AC adapter.

As shown in FIG. 5B, the design of the battery charger of FIG. 5A is modified to add diode D1 in parallel with the transistor Q1 (in addition to the diode D2 across transistor Q2), and to add resistor R3 between Vbattery and node N1.

Node N1 corresponds to the control input 410 of the step up DC-DC converter 310 shown in FIG. 4. The resistor network 406 and transistor 408 (controlled by error signal Ve) are similar to the same elements sharing the same reference numerals in FIG. 4. The error signal Ve controls whether the transistor 408 is off or on, and also controls the amount of current drawn from node N1 when the transistor 408 is on. Effectively, the error signal Ve controls the amount of supplemental power supplied by the battery through the circuitry shown in FIG. 5B to Vadapter.

In the state where current is being supplied from the battery (Vbattery) to the AC adapter (Vadapter), the circuitry of FIG. 5B is operated as a step up DC-DC boost converter instead of a step down DC-DC buck converter (for operation as a battery charger). When operated as a step up DC-DC converter, the transistor Q2 draws current from the battery through the inductor 508. When the diode D1 is activated, the current is drawn through the inductor 508 through the diode D1 to the AC adapter (Vadapter). Used in the step up DC-DC converter mode, Vbattery becomes the input, while Vadapter becomes the output, as, indicated by the arrows shown in FIG. 5B.

The control circuit 502 can be operated in the step up DC-DC converter mode by fooling the control circuit 502 into believing that the output current is higher than desired, and fooling the control circuitry into operating the DC-DC converter in continuous conduction mode. The control circuit 502 will respond by decreasing the PWM signal to transistor Q1, and increasing the PWM signal to transistor Q2. A signal proportional to the error signal Ve (explained in connection with FIG. 4) drives a small control current through the resistor R3, and the control circuit 502 sees the sum of the voltage drop across R3 and the voltage drop across the sense resistor Rs. If the drop across R3 is large enough, the average current through Rs decreases to zero. If the voltage drop across R3 becomes larger still, the average current in the circuitry shown in FIG. 5B reverses, and the voltage drop across Rs also reverses. If continuous conduction mode is maintained, the control loop of the buck converter may be used while the DC-DC converter is in step up mode.

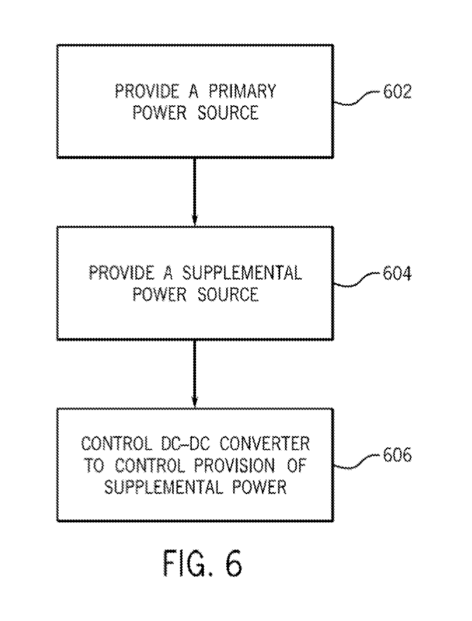

FIG. 6 is a flow diagram of a process according to some implementations applicable for the circuitry depicted in any of FIGS. 1, 3A-3D, 4, and 5B. The technique includes providing (at 602) a primary power source to supply power to a load in an electronic device, and providing (at 604) a supplemental power source. A DC-DC converter is controlled (at 606) to control provision of supplemental power from the supplemental power source to the load. Controlling the DC-DC converter includes preventing power from being supplied from the supplemental power source to the load if a power demand of the load can be met by the primary power source. Controlling the DC-DC converter further includes activating the DC-DC converter to supply a current that is combined with an output of the primary power source if the power demand of the load exceeds an amount of power that can be met by the primary power source.

Using techniques or mechanisms according to some implementations, power from multiple sources can be supplied to a load in an electronic device to meet demands of the load.

In the foregoing description, numerous details are set forth to provide an understanding of the subject disclosed herein. However, implementations may be practiced without some or all of these details. Other implementations may include modifications and variations from the details discussed above. It is intended that the appended claims cover such modifications and variations.

What is claimed is:

1 An electronic device comprising:
a load (106, 306);
a primary power source (102, 302) having an output connected to the load;
a supplemental power source (104, 304);
a DC-DC converter (110, 310) to receive power from the supplemental power source; and
switch circuitry (108) to selectively connect an output of the DC-DC converter to an output of the primary power source for supplementing power to the load in response to an overload condition of the primary power source.

2. The electronic device of claim 1, wherein DC-DC converter is configured to provide a current source to provide a current sourced from the supplemental power source to the load.

3. The electronic device of claim 2, wherein the current from the DC-DC converter is summed with the output from the primary power source.

4. The electronic device of claim 1, further comprising:
circuitry configured to:
determine if current drawn from the primary power source exceeds a threshold, and
in response to determining that the current drawn from the primary power source exceeds the threshold, output a signal to control an amount of current drawn from the supplemental power source by the DC-DC converter for provision to the load.

5. The electronic device of claim 4, wherein the circuitry is configured to vary a level of the signal to control the amount of current drawn from the supplemental power source by the DC-DC converter for provision to the load, wherein varying of the level of the signal is based on an amount of current drawn from the primary power source that exceeds the threshold.

6. The electronic device of claim 1, wherein the switch circuitry includes one of (1) a switch between the output of the DC-DC converter and the load, and (2) enable circuitry that when off prevents power from being output by the DC-DC converter to the load, and that when on allows power to be output by the DC-DC converter to the load.

7. The electronic device of claim 1, wherein the supplemental power source is a battery, and the electronic device further comprises a battery charger to charge the battery.

8. The electronic device of claim 7, wherein the battery charger and the DC-DC converter are integrally formed together as part of an integrated module, wherein the integrated module has a first mode to operate as the battery charger, and a second mode to operate as the DC-DC converter.

9. The electronic device of claim 8, wherein the DC-DC converter is a step up DC-DC converter, and wherein the integrated module is configured to operate as a step down DC-DC converter in the first mode, and to operate as the step up DC-DC converter in the second mode.

10. The electronic device of claim 9, wherein if continuous conduction mode is maintained, a control loop of the step down DC-DC converter is used while the DC-DC converter is in the second mode.

11. The electronic device of claim 1, wherein the primary power source is one of an AC adapter, a solar panel, and a network power source.

12. The electronic device of claim 1, wherein the DC-DC converter is configured to pass through current from the supplemental power source to the load when the primary power source is unavailable.

13. A electronic device comprising:
a load (208);
a first power source (202) selected from the group consisting of a solar panel and network power source;
a DC-DC converter (204) to receive power from the first power source;
a second power source (206),
wherein each of an output of the DC-DC converter and an output of the second power source is configured to connect to the load to supply power to the load.

14. The electronic device of claim 13, wherein the second power source is a battery, and wherein power from the first power source is useable to charge the battery.

15. A method comprising:
providing a primary power source (102, 302) to supply power to a load (106, 306) in an electronic device;
providing a supplemental power source (104, 304); and
controlling a DC-DC converter (110, 310) to control provision of supplemental power from the supplemental power source to the load, wherein controlling the DC-DC converter comprises:
preventing power from being supplied from the supplemental power source to the load if a power demand of the load can be met by the primary power source, and
activating the DC-DC converter to supply a current that is combined with an output of the primary power source if the power demand of the load exceeds an amount of power that can be met by the primary power source.

16. The method of claim 15, further comprising:
determining whether a current drawn from the primary power source exceeds a threshold, wherein the controlling is based on the determining.

17. The method of claim 16, wherein determining whether the current drawn from the primary power source exceeds the threshold comprises:
producing a voltage that corresponds to a voltage drop across a sense resistor due to the current drawn from the primary power source flowing through the sense resistor; and
comparing the voltage to a threshold voltage.

18. The method of claim 15, further comprising:
determining that a combination of the primary power source and supplemental power source is unable to supply a power consumption of the load; and
in response to determining, throttling power consumption of the load.

19. A method comprising:
providing a first power source (202) selected from the group consisting of a solar panel and network power source, to supply power to a load (208) in an electronic device;
providing a DC-DC converter (204) to receive power from the first power source;
providing a second power source (206), wherein each of an output of the DC-DC converter and an output of the second power source is configured to connect to the load to supply power to the load; and
controlling the DC-DC converter (204) to control provision of power from the first power source (202) to the load, wherein controlling the DC-DC converter comprises:
preventing power from being supplied from the second power source (206) to the load if a power demand of the load can be met by the first power source, and
controlling the DC-DC converter (204) to supply a current that is combined with an output of the second power source (206) if the power demand of the load exceeds an amount of power that can be met by the first power source.
